(19) United States
(12) Patent Application Publication
(10) Pub. No.: US 2018/0180470 A1
(43) Pub. Date: Jun. 28, 2018

(54) LIGHT RECEIVER HAVING A PLURALITY OF AVALANCHE PHOTODIODE ELEMENTS AND METHOD FOR DETECTING LIGHT

(71) Applicant: SICK AG, Waldkirch (DE)

(72) Inventor: Stefan SEITZ, Waldkirch (DE)

(21) Appl. No.: 15/830,397

(22) Filed: Dec. 4, 2017

(30) Foreign Application Priority Data
Dec. 22, 2016 (EP) 16206062.8

(51) Int. Cl. G01J 1/44

(52) U.S. Cl. CPC G01J 1/44; G01S 17/08; G01J 2001/4466; G01J 2001/448

(57) ABSTRACT

A light receiver (22) having a plurality of avalanche photodiode elements (24) biased with a bias voltage above a breakdown voltage and thus operated in a Geiger mode in order to trigger a Geiger current upon light reception,

wherein the avalanche photodiode elements (24) form a plurality of groups,
wherein the light receiver (22) comprises
a plurality of bias voltage terminals for supplying groups with different bias voltages and/or a plurality of readout circuits (60, 62, 64), each associated with a group (72₁-72ₙ) and comprising a measurement path (60) and a blanking path (64) as well as a switching element (62) for selectively supplying the Geiger current, or a measurement current corresponding to the Geiger current, to the measurement path (60) or the blanking path (64).

The invention relates to a light receiver having a plurality of avalanche photodiode elements and to a method for detecting light.

The function of a light receiver is to generate an electrical signal from incident reception light. The detection sensitivity of simple photodiodes is not sufficient in many applications. In an avalanche photodiode (APD), the incident light triggers a controlled avalanche breakdown (avalanche effect). This multiplies the charge carriers generated by incident photons, and a photo current is produced, which is proportional to the light reception level, but significantly larger than in a simple PIN diode. In a so-called Geiger mode, the avalanche photodiode is biased above the breakdown voltage so that even a single charge carrier generated by a single photon can trigger an avalanche, which subsequently recruits all available charge carriers due to the strong field. Hence, the avalanche diode counts individual events like a Geiger counter from which the name is derived. Geiger mode avalanche photodiodes are also called SPAD (Single Photon Avalanche Diode).

The high radiation sensitivity of SPADs is used in a number of applications. These include medical technology like CT, MRI, or blood tests, optical measuring technology like spectroscopy, distance measurement and three-dimensional imaging, radiation detection in nuclear physics, or uses in telescopes for astrophysics.

Geiger APDs or SPADs thus are very fast, highly sensitive photodiodes on a semiconductor basis. One drawback of the high sensitivity is that not only a measurement photon, but also a weak interference event from ambient light, optical cross talk or dark noise may trigger the avalanche breakdown. The interference event contributes to the measurement signal with the same relatively strong signal as the received measurement light and is indistinguishable within the signal. The avalanche diode subsequently is insensitive for a dead time of about 5 to 100 ns and is unavailable for further measurements during that time. It is therefore common to interconnect and statistically evaluate multiple SPADs.

The breakdown voltage is the minimal bias voltage necessary for maintaining the desired Geiger mode for a SPAD. Strictly speaking, however, the detection efficiency and the gain are still zero at this limit. Only when the bias voltage exceeds the breakdown voltage are incident photons converted into corresponding Geiger current pulses. In case of ideal photon detection efficiency (PDE) of 100%, each incident photon would trigger a Geiger current pulse. This is not completely possible in practice. However, the PDE can be influenced by the magnitude of the applied bias voltage.

In order to set the operating point of the SPADs and accordingly their triggering sensitivity via a bias voltage provided externally, the anode-side and cathode-side connections of the individual SPAD cells of the light receiver are directly accessed from the outside. Thus, all SPADs are operated with a common bias voltage. Instead of the bias voltage, sometimes only the overvoltage is considered, i.e. the difference between bias voltage and breakdown voltage. The triggering probability increases with the overvoltage. In practice, there is a reasonable upper limit, because the triggering probability saturates at higher overvoltages, while undesired noise components increase disproportionately. The operating point set by means of the overvoltage enables a certain adaptation of the light receiver, but does not account for many situations with greatly varying or temporally fluctuating reception light conditions.

Then, larger light power either of useful light or interference light lead to saturation effects of individual pixels or entire areas. In particular in case that a large dynamic range is to be covered, important information about the reception light may be lost. Conventionally, it is attempted to avoid such situations by means of suitable optical design, with optical components such as lenses, diaphragms and filters, and to optimize the incidence of light on the light receiver. Some possible goals of such an optimized design are constant received light quantities and thus reception signal profiles independent of the distance and angle of a detected object, an exactly adjusted position of a reception light spot on the light receiver, avoiding saturated energetic hotspots within a reception light spot, or shielding the light receiver from ambient or stray light. Since these goals often compete with on another and at least cannot be commonly achieved with low costs, a variety of device variants are offered depending on the application.

Reliable detection in a light receiver also depends on reading out the internal information, in this case the Geiger current, with as little loss and distortion as possible. However, conventional readout circuits are too slow, i.e. they cannot handle high-frequency signals. In addition, currents from ambient light, or even pure interference events like dark noise, are read out like the actual useful signal.

WO 2011/117309 A2 proposes to provide a third electrode on the SPAD detector in addition to the anode and cathode for the providing the bias voltage, the third electrode being used for a capacitively coupled output of the Geiger current. This is to prevent that the readout is delayed by switching elements of the bias voltage. However, the document does not deal with the actual readout. It also does not improve the adaption of the light receiver to ambient or application conditions.

It is therefore an object of the invention to improve the detection in a light receiver.

This object is satisfied by a light receiver having a plurality of avalanche photodiode elements biased with a bias voltage above a breakdown voltage and thus operated in a Geiger mode in order to trigger a Geiger current upon light reception, wherein the avalanche photodiode elements form a plurality of groups, wherein the light receiver comprises at least one of a plurality of bias voltage terminals or a plurality of readout circults, the bias voltage terminals providing different bias voltages in order to respectively supply the avalanche photo diode elements of a group with a same one of the different bias voltages and the readout circuits respectively being associated with a group of avalanche photodiode elements and each comprising a measurement path and a blanking path as well as a switching element for selectively supplying the Geiger current, or a measurement current corresponding to the Geiger current, to the measurement path or the blanking path.

The object is also satisfied by a method for detecting light with a plurality of avalanche photodiode elements which are biased with a bias voltage above a breakdown voltage and thus operated in a Geiger mode in order to trigger a Geiger current upon light reception, wherein the avalanche photodiode elements form a plurality of groups, wherein the avalanche photodiode elements are connected to at least one of a plurality of bias voltage terminals supplying the avalanche photodiode elements with different voltages so that the avalanche photodiode elements of at least one group are operated at a different bias voltage than the avalanche photodiode elements of another group and a plurality of readout circuits respectively being associated with a group of avalanche photodiode elements and each comprising a measurement path and a blanking path as well as a switching element, wherein the Geiger current of the avalanche photodiode elements of a group, or a measurement current corresponding to the Geiger current, is selectively supplied to the measurement path or the blanking path by switching the switching element.

When a bias voltage above the breakdown voltage is applied to the avalanche photodiode elements, they operate in Geiger mode. The avalanche photodiode elements are combined into groups. These can be a couple of avalanche photodiode elements which form a pixel having some statistics for compensating the susceptibility to individual interference events with subsequent dead time mentioned in the introduction. It is also conceivable to have larger groups forming entire regions of the light receiver, or whose avalanche photodiode elements are distributed over regions of the light receiver in a pattern, or groups consisting of only one single avalanche photodiode element.

The invention starts from the basic idea of providing these groups with different sensitivity properties by means of electronic control, i.e. to generate kind of an electronic aperture in analogy to an opto-mechanical aperture. To this end, it is possible to manipulate the input and/or the output of the avalanche photodiode elements, namely, by an adjustment of the bias voltage or by a selection at the readout, respectively. Both approaches have their own advantages. For example, an adjustment of the bias voltage enables an only gradual adjustment of the sensitivity, while on the other hand the selection during readout is extremely fast and thus particularly useful for high frequencies.

For a local adjustment of the bias voltage and thus the detection sensitivity, a plurality of different bias voltages are available on the light receiver, which are provided for the avalanche photodiode elements at bias voltage terminals externally or by a circuit of the light receiver. By supplying a group from one respective bias voltage terminal, the associated avalanche photodiode elements are supplied with a same one of the different bias voltages, and the groups have different sensitivities. The number of available bias voltages and groups in general is independent from one another. Multiple groups can be supplied with a same bias voltage, and an available bias voltage may also not be used by any group.

In order that a selection is possible during readout, a switching is provided in the readout circuit so that the associated avalanche photodiode elements can be treated differently. The Geiger current, or a measurement current corresponding to the Geiger current, can thus selectively be supplied to a measurement path or a blanking path. By means of the blanking path, the electronic aperture can be generated, which selectively switches certain avalanche photodiode elements to the blanking path. As a result, these regions are muted, or they are at least evaluated differently from avalanche photodiode elements whose readout circuit connects to the measurement path.

The invention has the advantage that, by using the electronic aperture, reception optics may be significantly simplified, or even be replaced. Processing strong light signals, or more general a large dynamic range, is facilitated. The function and optimization of the reception optics mentioned in the introduction, like suppressing interference light or avoiding distance or angle dependent effects, are also achieved, thus improving the performance of the light receiver, while saving optical elements like apertures, filters or lenses.

This creates additional degrees of freedom in placing components of a sensor using the light receiver, and simplifies miniaturization. The tolerance chain is shortened, the compensation of tolerances is simplified, and process reliability is increased. The electronic aperture also has a large field of applications, and due to large production numbers, the light receiver can be produced at low costs. Integrating avalanche photodiode elements with bias voltage supply and readout circuit, respectively, in one semiconductor process is simple and inexpensive.

An electronic aperture can be adjusted with electronic means alone, mechanical adjustment and devices to that end as well as mechanical means against misalignment are eliminated. Physical access for an adjustment is not necessary, and the electronic aperture is much easier to automate. An electronic aperture can generate aperture patterns which could only with difficulties, or not at all, be achieved by an optical aperture. It can be detected, at least in larger classes or groups, which avalanche photodiodes or groups, respectively, have responded to a light signal.

The light receiver preferably comprises an electronic aperture unit configured to adjust a sensitivity of avalanche photodiode elements by at least one of adjusting the bias voltage or switching the Geiger current to the measurement path or to the blanking path. The electronic aperture unit is a control or interface for the sensitivity adaption according to the invention by means of the bias voltage and/or a selection for readout. The electronic aperture unit can at least partially be integrated on a same chip as the light receiver. An implementation as a separate component or circuit is also possible, the electronic aperture unit is considered a part of the light receiver due to its function, irrespective of the physical implementation. The electronic aperture unit can adjust the sensitivity during various phases, for example as part of the factory setting, a calibration or adjustment during setup or maintenance, but also dynamically during operation. The respective specific sensitivity to be set, as well as the actual required bias voltages or selection setting for the readout circuit, can for example be parameters, tables or derived by an algorithm. Throughout this specification, preferably or preferred refers to an advantageous, but completely optional feature.

The electronic aperture unit preferably is configured to activate or deactivate regions of the light receiver. This results in an electronic aperture like an opaque optical aperture with no light transmission. It is achieved by lowering the bias voltage below the breakdown voltage, or by guiding the Geiger current into the blanking path during readout.

The electronic aperture unit preferably is configured to set a local sensitivity distribution of the light receiver. Here, the electronic aperture acts more like an optical filter with an adjustable attenuation effect. The sensitivity is adjusted by a corresponding adjustment of the bias voltage, or in this case more precisely the overvoltage above the breakdown voltage. An effect very similar to a sensitivity adjustment is possible in that a certain percentage of avalanche photodiode elements in a region are deactivated.

The electronic aperture unit preferably is configured to set a high sensitivity in a region of at least one light spot on the light receiver, and to set the remaining light receiver insensitive. Here, the electronic aperture takes the form of a classic aperture which suppresses regions around an incident light bundle. The insensitive regions can be deactivated, but also merely amplification and triggering probability be weakened with a lower overvoltage.

The electronic aperture unit preferably is adapted to adjust at least one of size and position of the region of the light spot to a distance of an object. The size is representative of the geometry, which usually simply scales with the size. The origin of the light spot is an incident light beam, often from a light transmitter assigned to the light receiver and possibly after a reflection or remission at an object. The size of the light beam differs in a near range and a far range depending on reception optics associated with the light receiver. With an offset of the optical axes of light transmitter and light receiver, there is a distance-dependent offset, which in case of a distance measurement by triangulation is the measurement effect. If the electronic aperture adjusts the region of high sensitivity correspondingly in dependence on the distance, a significantly improved signal-to-noise ratio is achieved, and saturation is avoided. The expected size and position, respectively, is determined in advance, for example theoretically or by a measurement. Sensitivity in the region of the light spot can additionally be increased with the distance, because a far object does not only cause a different size and/or position of the light spot, but also the overall light reception level is reduced.

The electronic aperture unit preferably is adapted to adjust at least one of size and position of the region of the light spot dynamically in dependence on the propagation speed of light. In this embodiment, the electronic aperture virtually follows a light signal, in particular a light signal of an associated light transmitter. This is very useful in a pulse-based light time of flight method. The electronic aperture corresponds, for any potential reception time, to the distance of an object which would be detected at that moment, or to the light spot generated by this object, respectively. It should be taken into account that only half the speed of light is relevant because the return path of a light signal remitted at the object needs to be considered. Typically, the relevant propagation speed is the vacuum speed of light, but a slower speed of light in different media is in principle possible. The adjustment can be continuous, but preferably is done stepwise, so that the avalanche photodiode elements have some time to adapt to the new sensitivity. As an alternative, the electronic aperture is adjusted more slowly, rather than dynamically within a measurement. For example, the distance of the object is determined by a previous measurement or estimation, or a target distance is preset.

The electronic aperture unit preferably is adapted to adjust the sensitivity to an intensity of reception light incident on the light receiver. In this embodiment, the electronic aperture has an effect as a dampening filter similar to self-darkening lenses. The intensity of the reception light preferably is measured, but can also be an estimated or preset value. Adjustment to the intensity can be combined with other effects of the electronic aperture, for example take effect only in a sensitive region, while other regions are deactivated.

The electronic aperture unit preferably is adapted to adjust the sensitivity to an intensity distribution of reception light incident on the light receiver. In this embodiment, there is an adjustment not only to a scalar intensity, but locally to an arbitrary light distribution on the light receiver.

The electronic aperture unit preferably is adapted to adjust the sensitivity inversely to the intensity distribution. Thus, the light receiver is particularly sensitive where there is only weak light, and conversely is comparably insensitive in particular bright regions where otherwise saturation could occur. The result is a homogenization. The adjustment to the distribution in a light spot preferably takes place prior to an actual measurement during a teach-in process.

The electronic aperture unit preferably is configured to set a high intensity in a plurality of mutually offset regions on the light receiver. The electronic aperture thus sis prepared for receiving a plurality of light spots. An application example is a multi-channel measurement, such as with a measurement channel and a reference channel or with two measurement channels which differ in wavelength or another property, or merely measure redundantly.

The electronic aperture unit preferably is configured to use information obtained in a separated region to adjust the sensitivity in another separated region. In this embodiment, one measurement channel is used to adjust the electronic aperture for the other measurement channel. The roles of the channels may be fixed, or one channel alternately is used for the setting of the other channel.

According to another preferred aspect of the invention, there is provided a sensor having at least one light receiver having a plurality of avalanche photodiode elements biased with a bias voltage above a breakdown voltage and thus operated in a Geiger mode in order to trigger a Geiger current upon light reception, wherein the avalanche photodiode elements form a plurality of groups, wherein the light receiver comprises at least one of a plurality of bias voltage terminals or a plurality of readout circuits, the bias voltage terminals providing different bias voltages in order to respectively supply the avalanche photo diode elements of a group with a same one of the different bias voltages and the readout circuits respectively being associated with a group of avalanche photodiode elements and each comprising a measurement path and a blanking path as well as a switching element for selectively supplying the Geiger current, or a measurement current corresponding to the Geiger current, to the measurement path or the blanking path.

The sensor preferably is configured for measuring distances. The distance can be determined by triangulation, as in a triangulating scanning sensor or a stereo camera. Preferably, the distance is measured with a light time of flight method. In this embodiment, the distance-measuring sensor preferably comprises, in addition to the light receiver according to an embodiment of the invention, a light transmitter for transmitting a light signal and a control and evaluation unit configured to determine the distance to an object from a light time of flight between transmitting the light signal and receiving the light signal which has been remitted by the object. For such a sensor, embodiments where the electronic aperture is adjusted to the distance of the object are particularly relevant because the actual distance is the measured variable of the sensor. The light signal preferably comprises a light pulse, so that the sensor measures distances with a pulse method. More complex signal shapes like double pulses or even pulse codes are conceivable. It is also possible to transmit a plurality of light pulses one after the other and to statistically evaluate the respective individual results, for example in a pulse averaging method. As an alternative, a phase method is possible, where the light spot also depends on the object distance. The light time of flight method can be used in a one-dimensional scanning sensor, in a laser scanner or in an image sensor of a 3D camera according to the light time of flight principle.

The sensor preferably is configured as a code reader or for data transmission, in particular in a data light barrier capable of transmitting and receiving data via the light path which is monitored for objects blocking the light path. These are examples of applications. There are other examples, including sensors implementing combinations of the example applications.

As mentioned above, the electronic aperture has two possibilities to manipulate the light receiver, namely at the input by adjusting the bias voltage, or at the output by bypassing the Geiger current into a blanking path. Numerous embodiments are conceivable for both these possibilities.

At first, embodiments for the adjustment of the bias voltage will be explained. The avalanche photodiode elements of a group can preferably be selectively supplied with one of the different bias voltages. Preferably, there is a switching element between avalanche photodiode elements of at least one group and the bias voltage terminals. The switching element is one example of means for selecting a bias voltage for a group. The switching element preferably is a multiple switch between not only two, but several or all of the available different bias voltages. The switching element may operate based on a code, in particular a binary code, in order to have few switches or control bits also for a somewhat larger number of available bias voltages.

At least two of the plurality of bias voltage terminals preferably have an external connection. In particular, all bias voltage terminals may have an external connection. There, different external bias voltages may be provided. External bias voltage connections allow for a very simple circuit concept, where the terminals and the bias voltages are externally available and controllable.

At least one of the bias voltage terminals preferably is internal, wherein at least one voltage adjusting element for generating different bias voltages from one external voltage is provided. The voltage adjustment element adjusts the external bias voltage by a differential voltage, and additional bias voltages are generated with additional voltage adjustment elements or multiple differential voltages. Of course, the external voltage itself can also be used as one of the different bias voltages, in particular by selecting a zero difference voltage. A hybrid with several externally connected bias voltages terminals is also possible, although preferably all bias voltage terminals are internal. Then, only one single external voltage is required to generate and thus internally provide all bias voltages, which leads to significant savings in external circuitry and to space and cost advantages.

The voltage adjusting element preferably is configured for voltage subtraction. Then, preferably, an external voltage is applied to the light receiver which is too high, or corresponds to the highest required bias voltage, in order to provide sufficient reserve for the voltage subtraction. It is particularly simple in terms of circuitry to always compensate by voltage subtraction. However, a positive or additive compensation increasing the external bias voltage for example by means of a charge pump is conceivable as an alternative, provided one accepts the additional costs.

The voltage adjusting element preferably comprises a control for setting the bias voltage to be generated. This control in particular is externally accessible, for example a digital control. Thus, the values of the available different bias voltages are variable, and this can be used to provide suitable sensitivity levels, but also to adjust the sensitivity of the groups of avalanche photodiode elements which are connected to the respective bias voltage. There are thus two possibilities for varying the sensitivity, namely, to which of the different bias voltages a group of avalanche photodiode elements is connected, and the magnitudes of the available bias voltages, and these possibilities can be used alternatively or cumulatively depending on the embodiment.

The avalanche photodiode elements of at least one group preferably are fixedly connected to a respective bias voltage terminal. In particular, all groups are fixedly connected to a bias voltage terminal. This leads to a simplified design of the light receiver, but at the same time the variability is reduced. Adjustments are only possible by decreasing or increasing the bias voltage at the bias voltage terminals.

The groups preferably form a checkerboard pattern, a concentric pattern, or several laterally displaced regions. These are some advantageous examples of a division into more sensitive and more insensitive regions, wherein depending on the embodiment the patterns are generated by hard wiring or dynamic interconnection of suitable groups to a respective same bias voltage. The pattern together with the associated bias levels define the behavior of the electronic aperture, wherein aperture patterns are possible which would be difficult or impossible to achieve with optical elements. A checkerboard pattern is representative of any pattern in which more sensitive and less sensitive avalanche photodiode elements are available in local alternation. This enables a simultaneous measurement with much and little signal, without delay which would emerge from a conventional sweeping or stepping through the sensitivity. A concentric pattern is suitable, for example, for a light spot whose size is distance-dependent, or which shifts into and out of focus during relative object movement. An example for a lateral displacement is the inevitable shift in a biaxial transmission and reception path, which in triangulation methods even is the desired measuring effect. It is also conceivable to use multiple regions for multiple measuring channels, for example a measuring channel and a reference channel, or regions for several transmitters having different properties, in particular wavelengths.

At least one bias voltage terminal preferably provides a bias voltage above the breakdown voltage and at least one bias voltage terminal preferably provides a bias voltage below the breakdown voltage. The Geiger mode can thus be selectively switched on and off. This is practically equivalent to switching on and off the light reception, since the gain factor in the Geiger mode is of the order of 10⁶.

Bias voltage terminals preferably provide different bias voltages above the breakdown voltage. Gain and triggering probability of the avalanche photodiode elements are related to the overvoltage. The effect of an electronic aperture can thus not only be achieved binary, i.e. as a switching off in case the bias voltage is below the breakdown voltage, but there is a gradual reduction corresponding to an aperture which has intermediate levels of attenuation. Preferably, in a hybrid embodiment, the bias voltage terminals provide at least one bias voltage below the breakdown voltage and several different overvoltages.

The avalanche photodiode elements preferably are red-sensitive. These avalanche photodiode elements have a particularly strong property of varying their quantum efficiency, thus the triggering probability and ultimately the sensitivity, with the bias voltage. Therefore, these avalanche photodiode elements are particularly suitable for an adjustment with an electronic aperture.

Further embodiments relate to the readout. The blanking path preferably is configured to let the Geiger current or the measurement current be drained without reading out.

This is the electronic counterpart to the optical effect of an aperture, blocking the light and thus the input signal. Incident light on avalanche photodiode elements whose readout circuits supply the Geiger current or measurement current to the blanking path therefore does not generate a measured signal and thus is practically lost in the electronic aperture. However, the electronic aperture does not necessarily have this effect. As an alternative, the Geiger current or measurement current in the blanking path can also be measured. This measurement information can, for example, be used to further adapt the electronic aperture, i.e. to switch the readout circuit of some avalanche photodiode elements, or to gain information about the incident signal and e.g. interference light components.

A signal detection circuit preferably is provided for the readout circuit and the associated individual avalanche photodiode element or the associated group of avalanche photodiode elements, the signal detection circuit comprising an active coupling element having an input connected to the avalanche photodiode elements and an output which maps the Geiger current at the input to the measurement current corresponding to the Geiger current in its course and level, wherein the input forms a virtual short-circuit for the Geiger current to a potential and the output is decoupled from the input. Preferably, there are as many readout circuits as signal detection circuits, which group and assign the existing avalanche photodiode elements in the same way. The readout circuit can in particular be connected directly or indirectly to the avalanche photodiode elements and the signal detection circuit. The signal detection uses an active decoupling method which is highly sensitive and very fast. In this case, the avalanche photodiode element is virtually shorted in terms of AC voltage, so that when the avalanche is triggered, there are only small voltage changes between the connections, and thus only very small charges are exchanged between parasitic capacitances of the avalanche photodiode elements which therefore have only a small effect on the output signal quality and bandwidth.

This active signal detection is particularly advantageous for the invention and is therefore explained in more detail. The avalanche photodiode elements in the Geiger mode or SPADs practically have the function of highly light-sensitive switches, which trigger a Geiger current upon incidence of light. Conventional means of signal detection are not able to reflect the very fast events in the measurement signal during an avalanche breakdown because of insufficiently optimized circuits. Therefore, the active coupling element is provided, rather than merely passive elements such as a resistor or a transformer. The active coupling element provides at its input a virtual short circuit for the Geiger current against a preferably fixed potential. In practice, this will only be possible down to a few Ohms or fractions of one Ohm. However, this means that the Geiger current is able to almost completely flow out of the detector, i.e. the respective triggering avalanche photodiode element, and via the short circuit into the associated signal detection circuit, quite differently than for example in the case of a simple measurement resistor. Then, the parasitic capacity formed by the plurality of avalanche photodiode elements does not any more have the effect of a low-pass filter, there remains almost no charge exchange. The fast, high-frequency Geiger currents can flow basically completely towards the amplifying element. Furthermore, the coupling element actively generates a measurement current at its output which corresponds to the Geiger current and thus in particular shows the same time profile. The active coupling element can also provide a level of the measurement current suitable for further processing by amplification. At the same time, the measurement current is decoupled from the Geiger current almost completely by the active coupling element. The further processing of the measurement current does not affect the Geiger current. Since the current available during the detection event can flow almost completely into the active coupling element, an optimal gain with a very good signal-to-noise ratio is obtained.

Because of the active coupling element, the course of the measurement current preferably deviates significantly from the Geiger current due to frequency-dependent losses only for changes in the higher gigahertz range, in particular above two or three GHz. Only for frequencies of the incoming light signal above a few GHz, the mapping of the Geiger current to the measurement current shows clearly perceptible frequency-related losses. In contrast, in conventional solutions, the measurement signal drops by several decades even at medium frequencies of several hundred MHz. Thus, the active coupling element enables detection even of very short pulses and edges in the sub-nanosecond range.

The coupling element preferably is configured to maintain a constant level of the input-side voltage. Then, when a Geiger current flows, an output current must flow from the output through the coupling element to maintain the voltage. In this way, the Geiger current at the input is mapped to a corresponding measurement current at the output.

The coupling element preferably comprises a signal detection transistor. In particular, this is exactly one signal detection transistor, and again preferably the coupling element consists of the signal detection transistor. The coupling element therefore is single-stage rather than multi-stage as for example in the case of a transimpedance amplifier conventionally used for readout. The technical nature of the signal detection transistor is not limited and includes bipolar transistors as well as field effect transistors in their different designs. However, a high frequency transistor preferably is used in order to actually achieve the inventive advantages of a high bandwidth of the light receiver.

The signal detection transistor is preferably operated in a base circuit or a gate circuit by connecting the input to the emitter or to the source, the output to the collector or to the drain, and the base or gate to a fixed potential. The terms which are alternatively mentioned in each case relate to a bipolar transistor on the one hand and to a FET on the other, in order to stress that the transistor is not limited to any particular technology. Although, in principle, the much more common emitter circuit would also be conceivable, the base circuit is superior in that it has a low input resistance, a higher bandwidth and flatter frequency characteristics.

The readout circuit preferably is connected to the input. This enables a particularly simple readout circuit which can access the Geiger current of the avalanche photodiode elements.

The readout circuit preferably comprises only one readout transistor. This is a particularly simple readout circuit, which is particularly suitable when a large number of readout circuits are provided for small groups or even individual avalanche photodiode elements. As already explained with respect to the signal detection transistor, a wide variety of technical embodiments are also possible for the readout transistor.

The base voltage of the signal detection transistor or of the readout transistor preferably is adaptable for switching between the measurement path and the blanking path. Depending on where the higher base potential is applied, the other transistor leaves the linear operation range and blocks. Therefore, the base voltage can be used to control whether the Geiger current flows via the signal detection transistor into the signal detection circuit and further into the measurement path, or via the readout transistor into the blanking path. Preferably, the base potential at the signal detection transistor remains constant in order to obtain a measurement without interference, and the adaption of the base potential takes place at the readout transistor.

The readout circuit preferably is connected to the output. In this embodiment, the Geiger current at first flows into the signal detection circuit and there is mapped to the measurement current. The further processing of the measurement current in the readout circuit, and in particular the switching between measurement path and blanking path, does not have any feedback on the Geiger current and the avalanche photodiode elements due to the decoupling in the signal detection circuit, which could not completely be ruled out in the case of a readout circuit connected to the input.

The readout circuit preferably comprises at least two parallel readout transistors each in a cascode circuit with the signal detection transistor. The readout transistors each form a branch point where the measurement path and the blanking path, respectively, begin. The switching is done via the base potential. The measurement current flows via the readout transistor having the higher base potential, with the other readout transistor leaving the linear operation range and blocking. By providing two readout transistors, the blocking voltage requirements of the two readout transistors as well as of the signal detection transistor can be reduced, so that parasitic effects and in particular parasitic capacitances are reduced and further improved high-frequency characteristics are achieved.

The blanking path preferably comprises a measurement tap. Geiger current or measurement current are thus not simply lost, but are also monitored in order to obtain additional measurement information, which can be used for the adaptation of the electronic aperture or even as an additional measuring channel.

The avalanche photodiode elements preferably comprise an electrode for providing the Geiger current with capacitive coupling, wherein the readout circuit is connected to the electrode. The connection is direct or indirect via the intermediate signal detection circuit. The electrode for providing the Geiger current preferably is a third electrode in addition to a first electrode and a second electrode for biasing the avalanche photodiode elements, in order to provide the bias voltage for feeding the avalanche breakdown. By having a third electrode independent of the provision of the bias voltage, a faster readout is possible. The electrode preferably is connected between the avalanche photodiode element and a charging unit for passive quenching and recovery. Preferably, the input of the signal detection circuit is connected to the third electrode. Thus, the signal detection circuit uses the electrode provided for fast readout. On the other hand, disadvantageous effects of the circuits for biasing on the readout are anyway suppressed by the active coupling element. Therefore, a fast readout is largely independent of the third electrode, which can thus alternatively not be provided or not be used. The signal detection circuit or the readout circuit, respectively, in this case is connected to the first electrode or the second electrode.

The inventive method can be modified in a similar manner and shows similar advantages. Further advantageous features are described in the sub claims following the independent claims in an exemplary, but non-limiting manner.

The invention will be explained in the following also with respect to further advantages and features with reference to exemplary embodiments and the enclosed drawing. The Figures of the drawing show in:

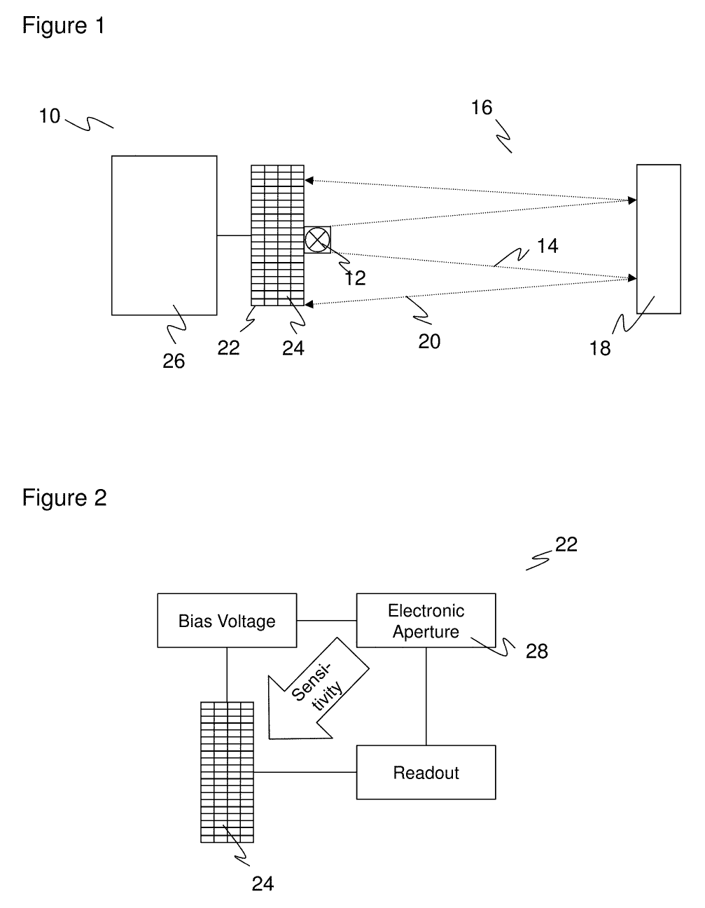

FIG. 1 a schematic representation of an optoelectronic sensor comprising a light receiver having a plurality of avalanche photodiode elements in Geiger mode;

FIG. 2 a simplified block diagram of a light receiver for explaining manipulations of an electronic aperture via bias voltage and/or readout;

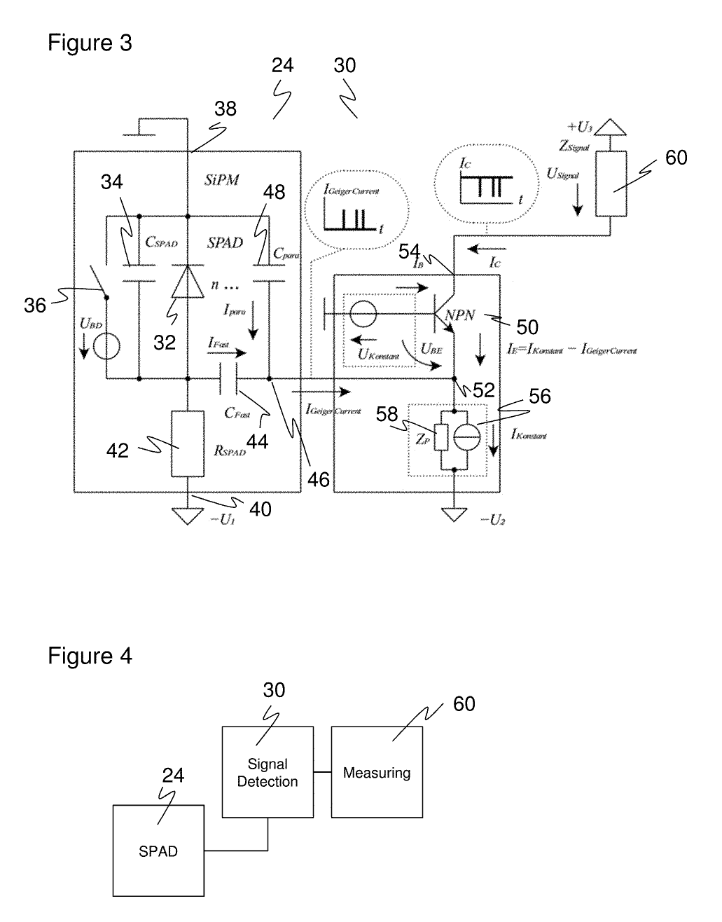

FIG. 3 a representation of a signal detection circuit for an avalanche photodiode element having an active coupling element;

FIG. 4 a simplified block diagram corresponding to FIG. 3;

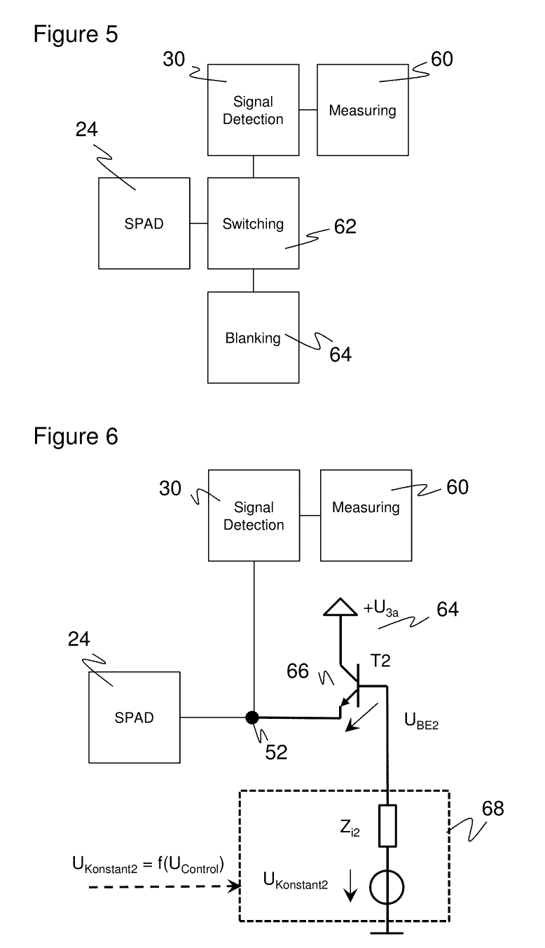

FIG. 5 a block diagram of an embodiment of a readout circuit for selectively switching between a measurement path and a blanking path prior to the signal detection;

FIG. 6 a representation of an exemplary circuitry for the readout circuit according to FIG. 5;

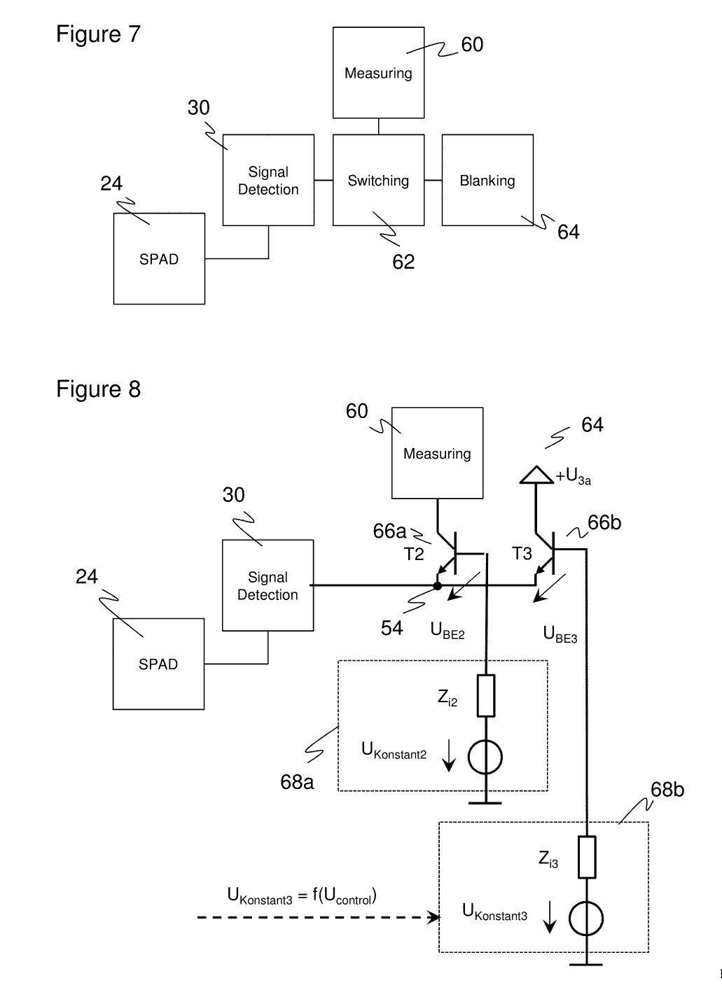

FIG. 7 a block diagram of an embodiment of a readout circuit for selectively switching between a measurement path and a blanking path after the signal detection;

FIG. 8 a representation of an exemplary circuitry for the readout circuit according to FIG. 7;

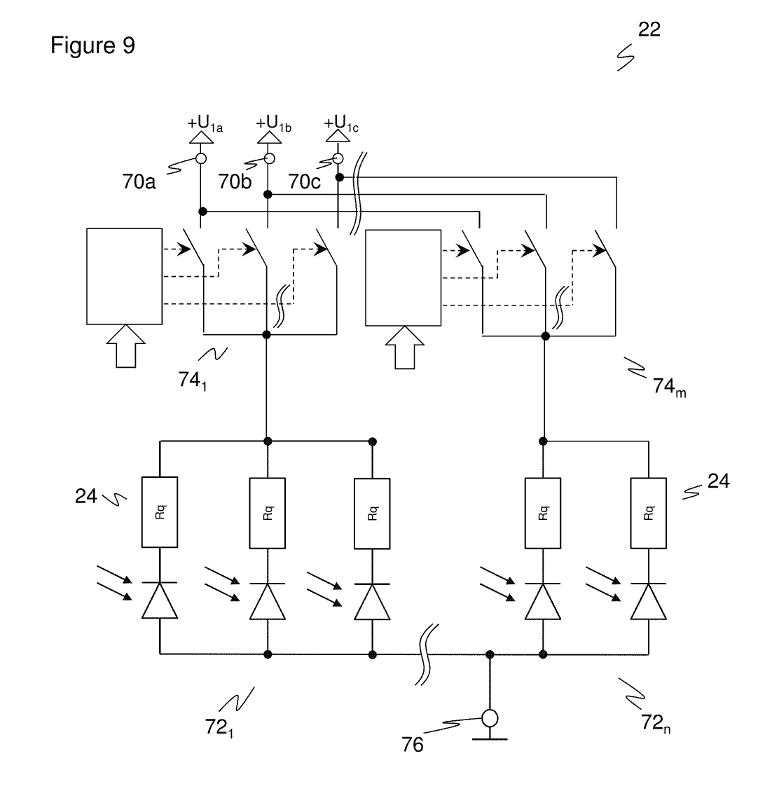

FIG. 9 a schematic circuit diagram of a light receiver supplying avalanche photodiode elements with different bias voltages by switching;

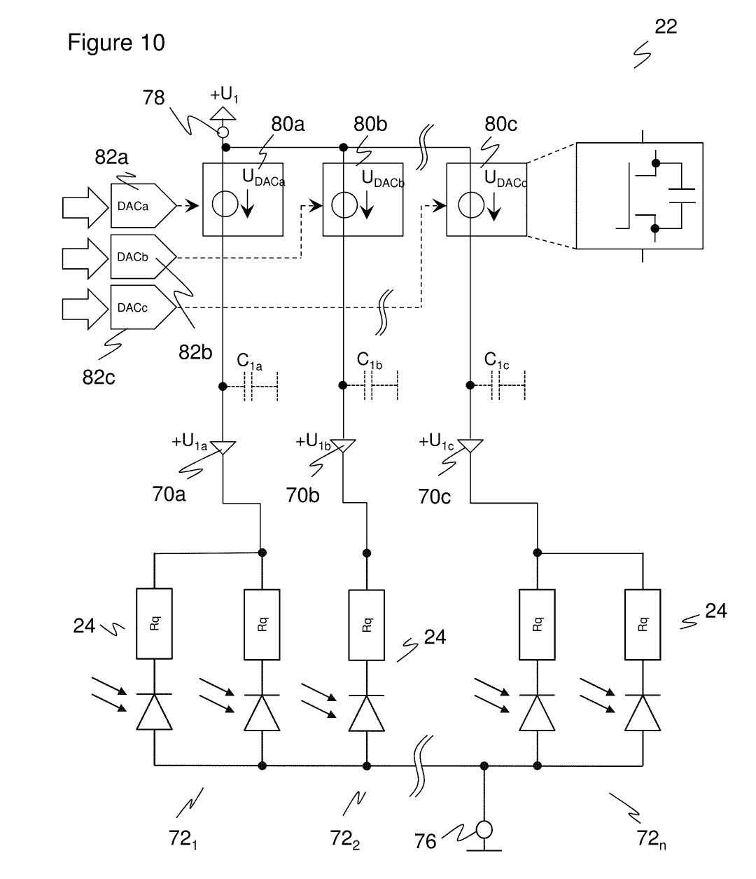

FIG. 10 a schematic circuit diagram of a light receiver supplying avalanche photodiode elements with different bias voltages by voltage subtraction;

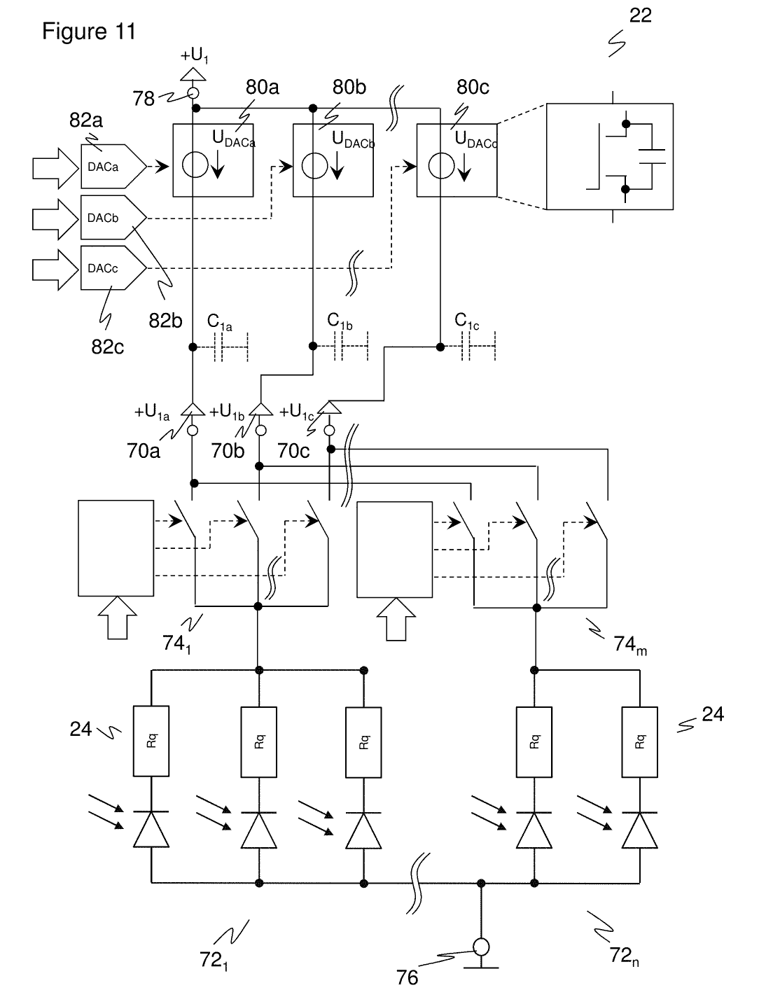

FIG. 11 a schematic circuit diagram of a light receiver supplying avalanche photodiode elements with different bias voltages by switching and voltage subtraction;

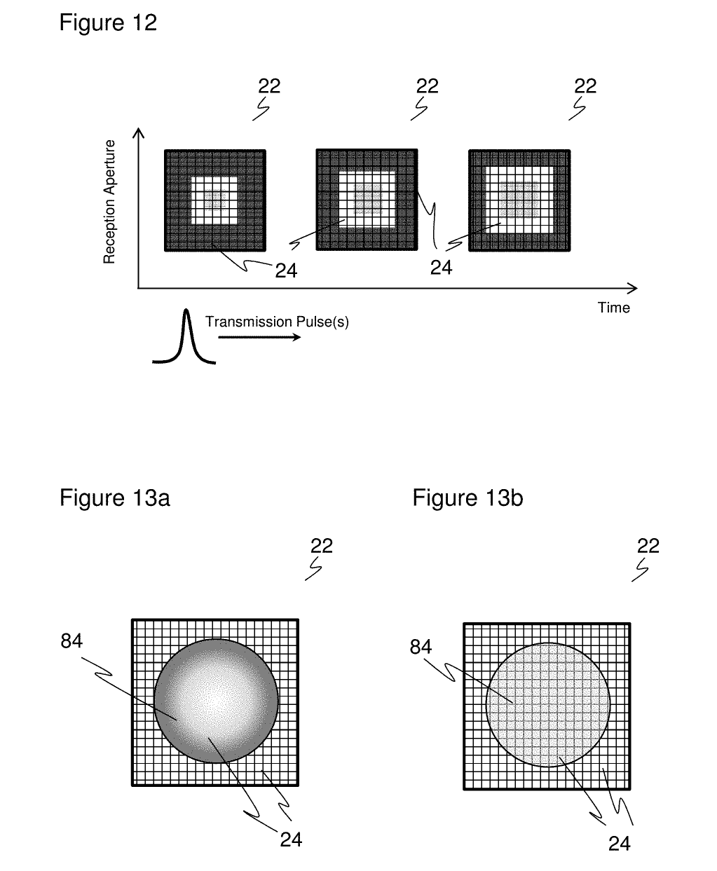

FIG. 12 an illustration of a distance-dependent adjustment of the electronic aperture;

FIG. 13a a representation of a reception light spot having an inhomogeneous intensity distribution on the light receiver;

FIG. 13b a representation of the light spot according to FIG. 13a after homogenization by adjusting an electronic aperture;

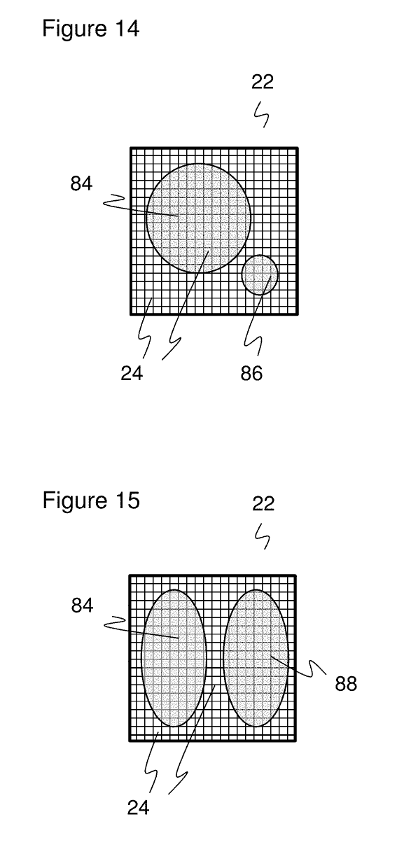

FIG. 14 a representation of two reception light spots on a light receiver which are used for a measurement channel and a reference channel; and

FIG. 15 a representation of two reception light spots on a light receiver which are used for a multi-channel measurement with different properties or for mutual adjustment of an electronic aperture.

FIG. 1 shows a schematic representation of an optoelectronic sensor 10 in an embodiment as a single-beam or one-dimensional scanning sensor. A light transmitter 12, for example an LED or a laser light source, transmits a light signal 14 into a monitoring region 16. In case it impinges on an object, part of the light signal is remitted or reflected and returns as remitted light signal 20 to a light receiver 22. The light receiver 22 comprises a plurality of avalanche photodiode elements 24 in Geiger mode or SPADs. The reception signals of the avalanche photodiode elements 24 are read out and evaluated by a control and evaluation unit 26.

In a practical embodiment, the sensor 10 has further elements, in particular transmission and reception optics and connections, which are not further explained for simplification. The separation of light receiver 22 and control and evaluation unit 26 in FIG. 1 is also conceivable in practice, but is mainly done for easier explanation. Preferably, these elements are at least partially integrated on a common chip whose area is shared by light-sensitive regions of the avalanche photodiode elements 24 and circuitry for their control and evaluation associated with individual avalanche photodiode elements 24 or groups of avalanche photodiode elements 24. Moreover, the optical arrangement with a light transmitter 12 covering a small part of the light receiver 22 is merely an example. Alternatively, other known optical solutions can be used, such as autocollimation for example with a beam splitter and common optics, or pupil division where two separate optics are provided and light transmitter and light receiver are arranged side by side.

The sensor 10 preferably is configured to measure distances. One possible embodiment is that the control and evaluation unit 26 determines a light time of flight from transmission of the light signal 14 until reception of the remitted light signal 20, and converts this into a distance via the speed of light.

The illustrated one-dimensional sensor 10 is only an example. An extension of the monitoring region 16 is possible by moving the beam, such as in a laser scanner, be it by a rotating mirror or by a rotating measurement head including light transmitter 12 and/or light receiver 22. In another embodiment, multiple one-dimensional systems are combined to form a light grid having multiple, usually parallel beams. In particular, the light grid is a scanning light grid measuring or monitoring distances with its beams. The avalanche photodiode elements 24 can be used individually or in groups for a spatially resolved measurement, thus forming a 3D camera. Moreover, mobile systems are conceivable where the sensor 10 is movably mounted.

FIG. 2 shows the light receiver 22 in a further very schematic representation. The avalanche photodiode elements 24 themselves form a matrix, where in other embodiments lines or other arrangements are also conceivable. According to the invention, the sensitivity of the light receiver 22 is locally adjusted. This is illustrated by an electronic aperture 28 which acts on the sensitivity of the avalanche photodiode elements 24. The electronic aperture 28 is a control, which may be a separate component as shown, but also at least partially be integrated with the light receiver 22 and/or the control and evaluation unit 26.

The electronic aperture 28 has two means of manipulation, namely, via the readout of the Geiger current generated in the avalanche photodiode elements 24, or via an adjustment of the bias voltage. This results in a very flexible, locally adjustable aperture effect, which basically deactivates regions of the light receiver 22 like an opaque optical aperture, or which increases or decreases sensitivity like a half-transparent aperture or an optical filter. Both means of manipulation will now be explained with reference to FIGS. 3 to 8 and FIGS. 9 to 11, respectively.

FIG. 3 shows, as a starting point, a representation of an avalanche photodiode element 24 having a signal detection circuit 30 which is optimized for sensitivity and bandwidth. The readout circuit which subsequently will be explained with reference to FIGS. 5 to 8 can also be used without the advantageous signal detection circuit 30, but preferably is based thereon.

The avalanche photodiode element 24 is shown in a simplified circuit diagram. The actual structure of the semiconductor component is assumed to be known and is not shown. A corresponding component can, for example, be produced in a CMOS process. The breakdown voltage of the avalanche photodiode elements 24 is significantly lower than in the case of conventional avalanche photodiodes, for example at most 50 V or 30 V.

On the one hand, the avalanche photodiode element 24 shows the behavior of a diode 32. It also has a capacitance, which is represented by capacitor 34 in parallel connection. An avalanche breakdown is triggered by at least one incident photon, which process acts as a switch 36. In a ready state, there is a voltage above the breakdown voltage across the diode 32 between a connector 38 and a connector 40. In case that an incident photon generates a charge carrier pair, this virtually closes the switch 36 so that the avalanche photodiode element 24 is flooded with charge carriers and there flows a so-called Geiger current. However, new charge carriers are generated only as long as the electric field remains strong enough. If the capacitor 34 is discharged far enough so that the voltage becomes lower than the breakdown voltage, the avalanche will automatically run out (“passive quenching”). Thereafter, the capacitor 34 is charged from the connectors 38, 40 via a resistor 42 until the voltage across the diode 32 again exceeds the breakdown voltage. There are alternative configurations in which the avalanche is detected from the outside and then a discharge below the breakdown voltage is triggered (“active quenching”).

During the avalanche, the output signal rises rapidly and independently of the intensity of the triggering light to a maximum value and then drops again after the avalanche has been quenched. The time constant of the decay, which corresponds to a dead time of the avalanche photodiode element 24, is typically in the range of several to several tens of nanoseconds. The dead time is not an absolute dead time because, as soon as the bias voltage is large enough to support an avalanche, the output signal can also rise again, although not as much as from the ready state. The gain factor is up to 10⁶ and is essentially the result of the maximum number of charge carriers which can be recruited by the avalanche in the avalanche photodiode element 24.

The task of the signal detection circuit 30 is to obtain a measurement signal from the Geiger current during an avalanche breakdown by utilizing as much of the full current flow as possible, while preserving the high-frequency components and achieving a high signal-to-noise ratio. The signal transfer preferably is done in a capacitive coupling via a coupling capacitor 44. In the shown embodiment, the avalanche photodiode element 24 preferably comprises a separate connector 46 for the readout of a measurement signal, the connector 46 being connected via the coupling capacitor 44. Avalanche photodiode elements 24 not comprising the separate connector 46 are also conceivable. In that case, one of the connectors 30, 40 takes over its function, and preferably a capacitor is connected in parallel to the resistor 42 for improving the high-frequency characteristics.

In a light receiver, a plurality of avalanche photodiode elements 24 preferably is provided. For this purpose, the entire arrangement according to FIG. 3 can be multiplied, i.e. each avalanche photodiode element 24 has its own signal detection circuit 30. Alternatively, avalanche photodiode elements 24 are combined in groups and are commonly read out. From the point of view of the illustrated avalanche photodiode element 24, these other avalanche photodiode elements, which are not shown in FIG. 3, are parasitic capacitances 48, which can be further increased by other parasitic effects. The parasitic capacitance 48 is accumulated over the further avalanche photodiode elements, whose number in typical applications can be large, and can therefore be significantly larger than the capacitance of the associated coupling capacitor 44. The parasitic capacitance 48 has the effect of a low-pass filter blocking high-frequency signals.

The signal detection circuit 30 should have, at the same time, a small signal resistance for achieving high speeds or bandwidths, respectively, and a large resistance for high sensitivity. In order to meet these contradictory requirements, the signal detection circuit 30 uses an active switching solution with an active coupling element 50, which is a bipolar NPN transistor in a base circuit in the embodiment of FIG. 3. Other active elements are conceivable, in particular other transistors (FET), another polarity (PNP) or another circuit (emitter circuit). In addition, a plurality of transistors can also be used instead of a single-stage circuit.

The active coupling element 50 has several significant advantages for the signal detection. Firstly, it provides virtually no resistance for the Geiger current, which is capacitively tapped as a current pulse, i.e. it forms a virtual short circuit. This cannot be achieved completely in practice, but less than one Ohm is quite possible. The effect is that there are no relevant voltage fluctuations across the parasitic capacitance 48 in spite of the avalanche, and thus not charge exchange and no current flow. Therefore, almost the entire Geiger current flowing through the coupling capacitor 44 is available to the active coupling element 50 at the input side. Without the virtual short circuit, a considerable part of the Geiger current would be lost in the parasitic capacitance 48, and especially the fast, high-frequency signal components would be suppressed due to the low pass behavior.

Secondly, the coupling element 50 at its output side generates a measurement current which corresponds to the Geiger current in its temporal course and level. The coupling element 50 may also modify, in particular amplify, the measurement current with respect to the Geiger current by its transfer function in a desired and specified manner. For that purpose, almost the entire current of the avalanche breakdown is available at the coupling element 50. The measurement current is subsequently available at the output side as the detection result for further processing. The measurement current is supplied from a current source of the active coupling element 50 and not from the avalanche photodiode element 24.

Thirdly, input circuit and output circuit are decoupled from one another. The further processing of the measurement current therefore has no impact on the Geiger current, within the technical limits of a real decoupling. Therefore, virtually any successor stages are possible, which in contrast to conventional signal detections do not have unfavorable feedback effects on the Geiger current.

In the specific example of FIG. 3, the emitter of the active coupling element 50 forms the input 52, where the Geiger current is supplied from the connector 46 of the avalanche photodiode element 24. The base is connected to ground or, more generally, to a fixed potential and thus virtually shorted. The collector forms the output 54 where the measurement current is provided. In the emitter circuit of the transistor, there is also a constant current source 56 between input 52 and a supply voltage −U₂. Therefore, at times outside avalanche breakdowns, there flows a DC current which controls the operating point of the transistor. The constant current source 56 may alternatively be passively implemented by a resistor 58, or as a combination of both, as shown in FIG. 3. The measurement current is tapped at the output 54. This is done in a measurement path 60, which is shown in a purely exemplary implementation as a simple linear measuring impedance. The measurement path 60 can alternatively comprise any measuring circuits with active and/or passive elements. Due to the decoupling by the signal detection circuit 30, these measuring circuits in the measurement path 60 practically do not affect the actual measurement.

FIG. 4 again shows the circuit arrangement of FIG. 3 for a high-sensitive detector of high bandwidth in a very coarse block diagram, where the avalanche photodiode element 24 indicated by SPAD, the signal detection circuit 30, and the measurement path 60 each are merely represented by a function block. This is intended to facilitate the understanding of the readout circuit to be added, which is now to be explained.

FIG. 5 shows, for a first overview, a block diagram which expands the hitherto single output signal line for a single output signal of the measurement path 60. A switching element 62 is connected to the avalanche photodiode element 24, which selectively directs the Geiger current into a blanking path 62 or, as before, into the measurement path 60 via the signal detection circuit 30. In an application example, the switching element 62 connects a first group of avalanche photodiodes 24 with the blanking path 64 and a second group of avalanche photodiodes 24 with the measurement path 60. In this way, the reception signals of the first group are electronically muted.

FIG. 6 shows a specific circuit example. A readout transistor 66 is connected with its base to an input 52 of the signal detection circuit 30. The base potential is adjusted with a controllable voltage source 68. If the base potential at the readout transistor 66 is above the base potential of the transistor 50 of the signal detection circuit 30, its amplification effect is lost, which corresponds to a switch-off of the measurement path 60. The Geiger current is redirected to the readout transistor 66 and is drained via the blanking path 64. Conversely, if the base potential is higher at the transistor 50, the Geiger current flows into the signal detection circuit, and the measurement current generated therefrom flows into the measurement path 60.

Since it is the ratio of the base potentials which is relevant, the control can also take place via the transistor 50 of the signal detection circuit 30 as an alternative to controllable voltage source 68. In principle, the blanking path 64 can be configured not only as a pure bypass for draining the Geiger current, but comprise further circuit components in order to gain information about the Geiger current.

The readout circuit according to FIG. 6, which is based on a single readout transistor 48, is particularly simple. This is particularly advantageous in case of reading out avalanche photodiode elements 10 in small groups or even individually, because in that case numerous readout circuits are required.

FIG. 7 shows a further embodiment of the readout circuit, again as a very simplified block diagram for a first overview. In contrast to FIG. 5, the switching element 62 for switching between measurement path 60 and blanking path 64 in this case is arranged downstream the signal detection circuit 30. The readout circuit therefore is decoupled from the input 52 and thus the avalanche diode elements 24 by the signal detection circuit 30, is not an additional capacitive load or another coupling path for interference. Switching of the switching element 62 is virtually without feedback, because the input 52 is actively maintained at a constant potential by the transistor 50.

However, this robustness requires a somewhat more complex circuitry as compared to FIG. 6 and shown as an example in FIG. 8. Now, two readout transistors 66a-b are provided, which are connected to the transistor 50 of the signal detection circuit 30 via the input 54 in parallel and each in a cascode arrangement. On the collector side, the measurement path 60 is connected to the first readout transistor 66a, and the blanking path 64 is connected to the second readout transistor 66b. A measurement current directed to the measurement path 66, for example, is detected in a measuring termination, while a measurement current in the blanking path 64, in accordance with an electronic aperture, does not contribute to the measurement result. However, as already mentioned, the blanking path 64 is not necessarily a pure bypass where the measurement current is drained and thus lost, but information on the measurement current could also be detected in the blanking path 64, if required.

Now, the measuring current, i.e. the collector current of the transistor 50 which is determined by the Geiger current, is selectively directed to the measurement path 60 or the blanking path 64 by the first readout transistor 66a or the second readout transistor 66b, respectively. This depends on which of the readout transistors 66a-b has the higher base potential, where purely as an example in the case of FIG. 8 the first readout transistor 66a has a constant voltage source 68a and the control takes place via a controllable voltage source 68b of the second readout transistor 66b. The voltage sources 68a-b could also be connected in reverse order, or both could be configured controllable.

The cascode circuit according to FIG. 8 does not only improve the decoupling to the avalanche photodiode element 24 via the signal detection circuit 30, but also again improves the high frequency characteristics, because the voltage requirements of the two readout transistors 66a-b as well as that of the signal detection transistor can be reduced, which in turn further reduces parasitic variables and in particular capacitances.

The respective cascode can, as an alternative to the representation, also be implemented as a combination of a bipolar transistor and a FET transistor or as two FET transistors. In principle, a cascode is even possible without a readout circuit having two readout transistors 66a-b and only in connection with a signal detection circuit 30. This would be an example of an alternative embodiment of measurement path 60 in FIG. 3, where the simple measurement resistor is replaced by an active circuit.

The decision between the two embodiments having a readout circuit which is connected either to the input 52 of the signal detection circuit 30 as in FIGS. 5 and 6 or to the output 54 as in FIGS. 7 and 8, using the decoupling, can be based on criteria such as performance, complexity and costs. Both embodiments have in common that there is a digital electronic aperture when the Geiger current or measurement current is drained in the blanking path 64 without any detection. With specific shifts of the operating point by controlling the base potential, the transistors 50, 66, 66a-b are shifted from a linear operation to a blocking operation, and this selects either the measurement path 60 or the blanking path 64. These processes can be very fast via a 3V technology. The small coupling impedance near a short circuit of the signal detection circuit 30 at its input 52 is maintained in the blanking state, i.e. while it is switched to the blanking path 64.

FIG. 9 shows a schematic circuit diagram of the light receiver 22 whose avalanche photodiode elements 24 are biased to different degrees via multiple bias voltage terminals 70a-c, and can thus be adjusted in their sensitivity. The avalanche photodiode elements 24 are each shown in a simplified form as a series connection of a diode and a quench resistor. This is purely by way of example, and any known implementation of SPADs is possible, in particular having a third connector 46 according to FIG. 3. The avalanche photodiode elements 24 are combined in groups, with only two groups 72₁-72ₙ being shown, although in practice there can be a large number of groups, up to the limiting case where individual avalanche photodiode elements 24 already form a group. In this context, there is a tradeoff between circuit complexity and flexibility.

The bias voltage terminals 70a-c are part of a circuit which enables to supply the groups 72₁-72ₙ with different bias voltages. In this embodiment, the specific selection which of the bias voltage terminals 70a-c is connected to a respective group 72₁-72ₙ is done with a 1-to-n-decoder or switching element 74₁-74ₘ. Thereby, one of the bias voltages of the bias voltage terminals 70a-c is switched to the avalanche photodiode elements 24 of a group 72₁-72ₙ. A simple multiple switch as a switching element 74₁-74ₘ is purely exemplary, and for example a binary or 2n-coded voltage selection is also conceivable for reducing the number of control bits for setting the respective state of the switching elements 74₁-74ₘ. The selection bits can be stored in memory cells of the light receiver 22, where in a maximum configuration with groups 72₁-72ₙ each comprising only one avalanche photodiode element 24 there are individual memory registers per avalanche photodiode element 24 where the bias voltage to be used is stored.

The illustrated number of bias voltage terminals 70a-c and therefore the number of different bias voltages available is also exemplary, as well as the number of groups 72₁-72ₙ, and results from the specific requirements for the application of the light receiver 22. Usually, however, the number of bias voltage terminals 70a-c will remain manageable and on an order of magnitude less than ten, in order to limit the circuit complexity and because too fine a gradation of sensitivity will only result in comparatively small advantages, in particular in view of the fact that an avalanche photodiode element 24 can handle at least a certain dynamic range of the reception light on its own even with a fixed bias voltage.

The different bias voltages act like an electronic aperture for switching off certain groups 72₁-72ₙ or reducing their sensitivity. As already mentioned, the bias voltage changes the gain and, in particular for red-sensitive avalanche photodiode elements 24, also the quantum efficiency and thus the triggering probability. Consequently, a desired inhomogeneous sensitivity distribution of the light receiver 22 can be set via the different bias voltages. A bias voltage below the breakdown voltage virtually results in a switch-off to the comparably insensitive APD mode or, when the bias voltage is further reduced or zero, even in the PIN mode.

Variation of the overvoltage above the breakdown voltage gradually changes sensitivity, i.e. more or less optical power is required to obtain similar signal levels. Above a certain optical power, there is a saturation effect which results in information loss and a poorer signal-to-noise ratio due to background effects (e.g. dark count). This can be compensated for by different overlapping or non-overlapping sensitivities of other avalanche photodiode elements 24 by means of different bias voltages.

In FIG. 9, the avalanche photodiode elements 24 are connected to the different bias voltage terminals 70a-c from one side, in this case the cathode. On the opposite side, in this case the anode, there is a common terminal 76 having a fixed potential. The mirrored arrangement is also possible, where the different bias voltages are provided at the anode. In other embodiments, several potentials for setting different bias voltages are available for selection both at the anode and the cathode.

In an alternative embodiment, which is not shown, there are no switching elements 74₁-74ₘ, but the groups 72₁-72ₙ are fixedly connected to one of the bias voltage terminals 70a-c. In this case, there are ultimately only as many groups 72₁-72ₙ as there are bias voltage terminals 70a-c, because the assignment to a bias voltage cannot be varied. Hence, in such an embodiment, there are typically only two to five and preferably at most ten groups 72₁-72ₙ. The geometric arrangement is fixed by design.

FIG. 10 shows a schematic circuit diagram of a further embodiment for the supply of avalanche photodiode elements 24 with different bias voltages. Although the number of different bias voltage terminals 70a-c is typically limited in practice, significant circuitry costs are still necessary to provide the different bias voltages externally. Therefore, in FIG. 10, there is only one single terminal 78 for an external voltage.

Voltage adjustment elements 80a-c generate the required different bias voltages from the one external voltage and provide them at the bias voltage terminals 70a-c, which are now internal. Preferably, the voltage adjustment elements 80a-c use a voltage subtraction, for example similar to the operation of a linear regulator. In that case, the external voltage should correspond to a maximum value for a required bias voltage in order to provide sufficient reserve. In principle, it is also conceivable to add voltage, for example by means of a charge pump.

The voltage adjustment elements 80a-c comprise a control, in this example in the form of on-chip DA converters 82a-c. It is thus possible to set the bias voltages at the internal bias terminals 80a-c, the voltage gradation being defined by a bit resolution of the DA converters 82a-c and a difference voltage which is derived linearly or non-linearly. By the resulting bias voltage the sensitivity of the groups 72₁-72ₙ is defined in dependence on the overvoltage, or whether they are virtually switched off with a bias voltage below the breakdown voltage. The light receiver 22 may comprise memory areas for storing the controls. As an alternative to a digital control by means of the DA converters 82a-c, an analog control for example by means of a control current, a control voltage or a resistor circuit is also conceivable. Capacitors C1a-C1c shown with dashed lines may be necessary for a low-impedance supply of the avalanche photodiode elements 24, in particular in case the parallel capacitances of the voltage adjustment elements 80a-c shown on the upper right side, mostly parasitic capacitances, are not sufficient.

FIG. 10 shows three groups 72₁-72ₙ of avalanche photodiode elements 24 as an example. Since, in this example, the connection to the internal bias voltage terminals 70a-c is fixed, it may be advantageous not to form more groups 72₁-72ₙ than bias voltage terminals 70a-c. On the other hand, there could also be additional groups which differ in other properties although more than one group is fixedly connected to the same bias voltage terminal 70a-c.

FIG. 11 shows a circuit diagram of a further embodiment for supplying avalanche photodiode elements 24 with different bias voltages. This basically is a combination of the measures which have been explained with reference to FIGS. 10 and 11. Thus, on the one hand, multiple bias voltages are generated from one external voltage at a terminal 78 by means of voltage adjustment elements 80a-c, and the bias voltages are provided at internal bias voltage terminals 70a-c. On the other hand, switching elements 74₁-74ₘ are provided in order to selectively connect the groups 72₁-72ₙ to one of the bias voltage terminals 70a-c.

The circuit elements shown in FIGS. 9 to 11 are to be understood purely by way of example, and variants which are mentioned in the context of one Figure can also be used in the other embodiments. The actual implementation of the circuit elements is not fixed or limited, and for example depends on the semiconductor process for producing the light receiver 22. As already mentioned, the different bias voltages can also be provided at the cathode rather than at the anode as shown. The voltage and reference potentials may be shifted or reversed.

As already mentioned, the electronic aperture may be adjusted via the readout control explained with reference to FIGS. 3 to 8, or via an adjustment of the bias voltage explained with reference to FIGS. 9 to 99, or both possibilities are used.

The readout control is extremely fast and thus particularly suitable for high frequencies, and it does not have a feedback on the behavior in the avalanche photodiode elements 24 themselves. However, this kind of electronic aperture acts only late in the signal processing chain and thus cannot change processes in the avalanche photodiode elements 24, in particular saturation effects. The readout control has a binary effect, i.e. it completely activates or deactivates the effect of an avalanche photodiode element 24. A kind of graduation can be achieved in that only some percentage of avalanche photodiode elements 24 are deactivated in a region of the light receiver 22.

The bias voltage, on the other hand, allows an analog, gradual adjustment which takes effect directly at the input and thus extends the dynamic range, as well as prevents saturation of the avalanche photodiode elements 24. However, it cannot be ruled out that very fast changes of the bias voltage have repercussions on the avalanche photodiode elements 24, so that the high frequency characteristics are inferior to a readout control. Avalanche photodiode elements 24 with active quenching have a faster reset, thus faster recovering their full sensitivity, and further improve the dynamic range. In this way, active quenching may in particular improve the high frequency characteristics for bias voltage adjustments.

FIG. 12 shows an application example with a distance-dependent adaptation of the electronic aperture 28. The illustration is guided by the idea of a sensor 10 which measures the distance to an object 18 with a pulse-based light time of flight method. When the transmitted light signal 14 impinges on an object 18, the remitted light signal 20 generates a light spot on the light receiver 22. Its size, and depending on the optical design of the sensor 10 also its position, depends on the distance of the object 18. Since the light signal 14 propagates with the constant speed of light, the sensor 10 at any point in time can only receive a remitted light signal 20 from a known distance which increases according to the speed of light. Because of the return path of light signal 14 and remitted light signal 20, the distance strictly speaking increases at half the speed of light.

The electronic aperture 28 adapts to this expectation of size and position, possibly also to the shape of the light spot. As illustrated in FIG. 12, only a small part of the avalanche photodiode elements 24 shown in white is activated at the time of transmission. The surrounding avalanche photodiode elements 24 shown in black would only contribute interference events and are therefore muted or deactivated. The proportion of active avalanche photodiode elements 24 successively increases in order to adjust to the larger light spot upon reception of a remitter light signal 20 of a farther object 18. The adjustment can be continuous. Since the respective adjustments of the electronic aperture 28 are not instantaneous without repercussions, a stepwise adjustment is also conceivable, for example as shown in three stages for a near, middle and far distance range.

So far, the electronic aperture 28 is shown in black and white and thus binary. Instead of a complete activation or deactivation, a gradual adjustment is also possible, which merely reduces the sensitivity in transition regions or overall. In addition, there can be a graduation in the inner region of the electronic aperture 28, for example to somewhat dampen a particularly bright central area. This is indicated in FIG. 12 by avalanche photodiode elements 24 shown in grey, while this adjustment also may comprise a gradual spatial distribution or be distance-dependent, respectively. In the field of optics, one would rather speak of a transmission or attenuation filter, but here, the complete as well as the partial shading effects are referred to as electronic aperture 28. Of course, the simple rectangular geometries of the electronic aperture 28 in FIG. 28 are only by way of example. In practice, there is an adjustment to an expected or measured shape of the light spot, preferably a distance-dependent adjustment.

The electronic aperture 28 does not need to be adjusted in dependence on the distance with the fast temporal relation to the transmitted light signal 14 as explained so far. The distance value can also be known from an earlier measurement, in particular by iteration where distance measurement and electronic aperture 28 are successively measured and adjusted, respectively, with increasing precision. Further alternatives are to merely estimate a relevant distance range, or to set the sensor 10 to a certain distance. In all these cases, the electronic aperture 28 can be adjusted to the expected light spot in a certain distance or distance range in analogous to the representation in FIG. 12.

In contrast to optical apertures or filters, the electronic aperture 28 can be controlled with virtually any desired aperture and shading patterns, some of which would not even be possible on an opto-mechanical level. It is only necessary that a control is possible, which in turn depends on the definition of the groups 72₁-72ₙ which, however, can be defined down to the level of individual avalanche photodiode elements 24 if required. As a result, an undesired signal contribution of ambient and stray light can effectively be kept away from groups 72₁-72ₙ which are not required, or groups 72₁-72ₙ receiving too much useful light can be deactivated, respectively. The aperture effect may be digital and its function thus similar to the human iris. It is also possible not to have a digital aperture with activation and deactivation, but also to adjust sensitivity so that an optimal operating point of each group 72₁-72ₙ can be set.

FIG. 13 illustrates another embodiment of the electronic aperture 28 which acts like a transmission filter. It is not distance-dependent as in FIG. 12. However, it would be possible to combine the attenuation effect now to be described with reference to FIG. 13 with a distance-dependent control of the electronic aperture 28.

In a simple implementation, the electronic aperture 28 adjusts the sensitivity everywhere, i.e. as a scalar and comparable to sunglasses. For this purpose, the intensity of the incident light is measured or estimated. The light receiver 22 can have optimal dynamics due to the sensitivity adjustment.

In a somewhat more complex embodiment, the sensitivity is locally adapted to the intensity distribution of the incident light. FIG. 13a is an exemplary illustration of a light spot 84 having an inhomogeneous intensity distribution. In this example, the light spot 84 is significantly brighter in its center than at the edges. By adjusting the sensitivity inversely to this intensity distribution, the light spot 84 can be homogenized. This is shown in the illustration of FIG. 13b. It is not necessary that the sensitivity adjustment inverts the intensity distribution in a precise mathematical sense. Often it is enough to only somewhat attenuate particularly bright areas. On the other hand, the possible accuracy of the adjustment is only limited by the size of the groups 72₁-72ₙ. The sensitivity adjustment is preferably combined with an opaque aperture around the light spot 84, i.e. the avalanche photodiode elements 24 outside the light spot 84 shown in black are deactivated. A spatial sensitivity adjustment, for example to an intensity distribution of the incident light, may be combined with a time-dependent or distance-dependent adjustment.

FIG. 14 shows a further embodiment of the electronic aperture 28, which is now adjusted to two light spots 84, 86. There is a reference light spot 86 in addition to the light spot 84 for the actual measurement for example of the remitted light signal 20. This configuration can be used for a reference measurement for example of the kind having an optical short-circuit, for taking effects into account like delays of the light transmitter 12, tolerances in the transmitted light signal 14, or delays which are variable with process, temperature, and voltage.

FIG. 15 illustrated a generalization of a dedicated reference light spot 86 to an arbitrary second light spot 88 of a second measurement channel. Additional measurement channels and/or reference channels by additional light spots are also possible. There are numerous applications for a multi-channel measurement. In addition to a reference measurement in a light time of flight method, the two channels may be used to optimize the electronic aperture 28, either with a dedicated channel for obtaining the control information for the electronic aperture 28 and a dedicated measurement channel, or in alternate function of both channels. A real multi-channel measurement, with multiple measurement channels, can be used to cover different physical properties like multiple wavelengths of multiple transmitters. Another example is a redundant measurement for higher precision or increased reliability and fault detection. In all these cases, the electronic aperture 28 can optimally be adjusted to the measurement channels and thus eliminate or at least decrease interfering events from avalanche photodiode elements 24 which are not involved in the measurement of useful light.

All required settings of the electronic aperture 28 can already be taught in the production process, for example in the form of lookup tables (LUT). The teach-in of these tables or other setting information can be done systematically or individually for each device, preferably under defined operating conditions and environmental conditions. Further possibilities are a teach-in during setup of a sensor 10, or dynamic adjustments using the respective measurement information of the light receiver 22 during operation. The necessary position-related information about the reception light on the area of the light receiver 22 can be obtained by sequential activation of the individual groups 72₁-72ₙ, in particular also in dependence on a respective distance of the object 18, different object remissions and/or detection angles.

Compared to a conventional opto-mechanical aperture, the electronic aperture 28, and also electronic transmission filtering included in this term, is in effect directly integrated into the light receiver 22 on a same plane as the photosensitive surfaces. Therefore, there are no undesired angle-dependent parallactic shading or distortion effects of conventional optical elements, which inevitably can only be arranged at some distance.

1. A light receiver (22) having a plurality of avalanche photodiode elements (24) biased with a bias voltage above a breakdown voltage and thus operated in a Geiger mode in order to trigger a Geiger current upon light reception,
wherein the avalanche photodiode elements (24) form a plurality of groups (72₁-72ₙ),
wherein the light receiver (22) comprises at least one of a plurality of bias voltage terminals (70a-c) or a plurality of readout circuits (60, 62, 64),
the bias voltage terminals (70a-c) providing different bias voltages in order to respectively supply the avalanche photo diode elements (24) of a group (72₁-72ₙ) with a same one of the different bias voltages
and the readout circuits (60, 62, 64) respectively being associated with a group (72₁-72ₙ) of avalanche photodiode elements (24) and each comprising a measurement path (60) and a blanking path (64) as well as a switching element (62) for selectively supplying the Geiger current, or a measurement current corresponding to the Geiger current, to the measurement path (60) or the blanking path (64).

2. The light receiver (22) according to claim 1,
comprising an electronic aperture unit (28) configured to adjust a sensitivity of avalanche photodiode elements (24) by at least one of
adjusting the bias voltage
or switching the Geiger current to the measurement path (60) or to the blanking path (64).

3. The light receiver (22) according to claim 2,
wherein the electronic aperture unit (28) is configured to activate or deactivate regions of the light receiver (22).

4. The light receiver (22) according to claim 2,
wherein the electronic aperture unit (28) is configured to set a local sensitivity distribution of the light receiver (22).

5. The light receiver (22) according to claim 2,
wherein the electronic aperture unit (28) is configured to set a high sensitivity in a region of at least one light spot (84) on the light receiver (22), and to set the remaining light receiver (22) insensitive.

6. The light receiver (22) according to claim 5,
wherein the electronic aperture unit (28) is adapted to adjust at least one of size and position of the region of the light spot (84) to a distance of an object (18).

7. The light receiver (22) according to claim 5,
wherein the electronic aperture unit (28) is adapted to adjust at least one of size and position of the region of the light spot (84) dynamically in dependence on the propagation speed of light.

8. The light receiver (22) according to claim 2,
wherein the electronic aperture unit (28) is adapted to adjust the sensitivity to an intensity of reception light incident on the light receiver (22).

9. The light receiver (22) according to claim 2,
wherein the electronic aperture unit (28) is adapted to adjust the sensitivity to an intensity distribution of reception light incident on the light receiver (22).

10. The light receiver (22) according to claim 9,
wherein the electronic aperture unit (28) is adapted to adjust the sensitivity inversely to the intensity distribution.

11. The light receiver (22) according to claim 2,
wherein the electronic aperture unit (28) is configured to set a high intensity in a plurality of mutually offset regions (84, 86, 88) on the light receiver (22).

12. The light receiver (22) according to claim 11,
wherein the electronic aperture unit (28) is configured to use information obtained in a separated region (84) to adjust the sensitivity in another separated region (88).

13. An optoelectronic sensor (10) comprising at least one light receiver (22),
the light receiver (22) having a plurality of avalanche photodiode elements (24) biased with a bias voltage above a breakdown voltage and thus operated in a Geiger mode in order to trigger a Geiger current upon light reception,
wherein the avalanche photodiode elements (24) form a plurality of groups (72₁-72ₙ),
wherein the light receiver (22) comprises at least one of a plurality of bias voltage terminals (70a-c) or a plurality of readout circuits (60, 62, 64),
the bias voltage terminals (70a-c) providing different bias voltages in order to respectively supply the avalanche photo diode elements (24) of a group (72₁-72ₙ) with a same one of the different bias voltages
and the readout circuits (60, 62, 64) respectively being associated with a group (72₁-72ₙ) of avalanche photodiode elements (24) and each comprising a measurement path (60) and a blanking path (64) as well as a switching element (62) for selectively supplying the Geiger current, or a measurement current corresponding to the Geiger current, to the measurement path (60) or the blanking path (64).

14. The optoelectronic sensor (10) according to claim 13,
the sensor (10) being configured as a sensor (10) for measuring distances according to a time of flight method.

15. The optoelectronic sensor (10) according to claim 13,
the sensor (10) being configured as a code reader.

16. The optoelectronic sensor (10) according to claim 13,
the sensor (10) being configured for data transmission.

17. A method for detecting light with a plurality of avalanche photodiode elements (24) which are biased with a bias voltage above a breakdown voltage and thus operated in a Geiger mode in order to trigger a Geiger current upon light reception,
wherein the avalanche photodiode elements (24) form a plurality of groups (72₁-72ₙ),
wherein the avalanche photodiode elements (24) are connected to at least one of
a plurality of bias voltage terminals (70a-c) supplying the avalanche photodiode elements (24) with different voltages so that the avalanche photodiode elements (24) of at least one group (72₁-72ₙ) are operated at a different bias voltage than the avalanche photodiode elements (24) of another group (72₁-72ₙ)
and a plurality of readout circuits (60, 62, 64) respectively being associated with a group (72₁-72ₙ) of avalanche photodiode elements (24) and each comprising a measurement path (60) and a blanking path (64) as well as a switching element (62), wherein the Geiger current of the avalanche photodiode elements (24) of a group (72₁-72ₙ), or a measurement current corresponding to the Geiger current, is selectively supplied to the measurement path (60) or the blanking path (64) by switching the switching element (62).
